(19) United States
(12) Patent Application Publication
(10) Pub. No.: US 2023/0062168 A1
(43) Pub. Date: Mar. 2, 2023

(54) METHODS, SYSTEMS, AND APPARATUS FOR CHARGING A VEHICLE AND MINING CRYPTOCURRENCY

(71) Applicant: Brian H. Logan, Semmes, AL (US)

(72) Inventor: Brian H. Logan, Semmes, AL (US)

(21) Appl. No.: 17/805,972

(22) Filed: Jun. 8, 2022

Related U.S. Application Data
(60) Provisional application No. 63/239,149, filed on Aug. 31, 2021.

(51) Int. Cl. H02J 7/14; H02K 7/18; B60K 25/08; G06Q 20/06

(52) U.S. Cl. CPC H02J 7/14; H02K 7/1846; B60K 25/08; G06Q 20/065; B60K 2001/045

(57) ABSTRACT

Systems, methods, and a device which produces and stores electrical energy from primarily the forward movement of a vehicle is disclosed. This device has a variety of potential applications, such as use with a semitrailer and various types of electric vehicles. It also includes a number of features, such as functioning as a cryptocurrency mining rig that uses excess electricity generated, that add to its usefulness.

### CROSS-REFERENCE TO RELATED APPLICATION

This application claims the benefit of priority of U.S. provisional application No. 63/239,149, filed Aug. 31, 2021, the contents of which are herein incorporated by reference.

### BACKGROUND OF THE INVENTION

The present invention relates to cryptocurrency mining and electric vehicle (EV) charging and, more particularly, to a device that produces and stores electrical energy from primarily the forward movement of a vehicle and facilitates the mining of cryptocurrency.

EVs derive power to propel it forward from electricity, which is typically received from an energy storage device housed in the vehicle. Certain electric vehicles (e.g., hybrids) capture energy via regenerative charging vehicles include regenerative charging. Battery EVs are typically charged through a wired or wireless connection at a location, such as a household or a commercial charging station. Such charging systems are inconvenient (e.g., there are too few, they are often not located close to where the driver is, and provide power slowly). They also have other drawbacks, such as limited range, degradation during energy transference, losses and inefficiencies, needing to navigate to a particular location for charging, and the like. As such, alternatives for stationary wired or wireless charging systems and methods that efficiently and safely transfer energy for charging electric vehicles are desirable. Further, conventional cryptocurrency mining rigs (e.g., ones plugged into a home outlet with power provided by a power company) are power-hungry, often resulting in large energy bills with energy that is likely generated from a fossil fuel source.

As can be seen, there is a need for alternatives for stationary wired or wireless charging systems and methods that efficiently and safely transfer energy for charging electric vehicles. The present invention, in part, addresses the “limit” on EV range and the constraint of having to locate an EV charging station. Other uses include providing electrical power to a structure in the event of an emergency and/or the ability to supply electrical power in remote locations and for mining cryptocurrency. By re-utilizing the “wasted” forward energy, the present invention will advance EVs beyond their current limitations and provides an alternative way to mine cryptocurrency.

### SUMMARY OF THE INVENTION

In one aspect of the present invention, this unit can be used to sustain an EV and/or be used to charge an EV, to limit the need to frequent stops to recharge. Thus, saving time and money.

In another aspect of the present invention, the unit can also be used to mine cryptocurrency without the need of being plugged-in to a power company's grid, which will also save money.

In certain embodiments, a system of the present invention includes: a vehicle including a first axle and a first wheel mounted on the first axle, the first axle and the first wheel being configured to be driven to rotate; and a first power generation device operably coupled to the first axle such that rotation of the first axle causes electricity to be generated in the first power generation device.

These and other features, aspects and advantages of the present invention will become better understood with reference to the following drawings, description, and claims.

### BRIEF DESCRIPTION OF THE DRAWINGS

The following figures are included to illustrate certain aspects of the present disclosure and should not be viewed as exclusive embodiments. The subject matter disclosed is capable of considerable modifications, alterations, combinations, and equivalents in form and function, without departing from the scope of this disclosure.

FIG. 1 is a side elevation view of an embodiment of the present invention, in use;

FIG. 2 is a detail front elevation view of the embodiment of the present invention, in use;

FIG. 3 is an exploded schematic perspective view of the embodiment of the present invention;

FIG. 4 is a block diagram of the embodiment of the present invention;

FIG. 5 is a schematic perspective view of a second configuration of the embodiment of the present invention; and

FIG. 6 is a cross-sectional view of the embodiment of the present invention, taken along lines 6-6 of FIG. 1.

### DETAILED DESCRIPTION OF THE INVENTION

The subject disclosure is described with reference to the drawings, wherein like reference numerals are used to refer to like elements throughout. In the following description, for purposes of explanation, numerous specific details are set forth in order to provide a thorough understanding of the present disclosure such that one skilled in the art will be enabled to make and use the present invention. It may be evident, however, that the present disclosure may be practiced without some of these specific details. For the purpose of clarity, technical material that is known in the technical fields related to the present invention has not been described in detail so that the present invention is not unnecessarily obscured

Broadly, one embodiment of the present invention is a device that addresses the limit on EV range and permits mining of cryptocurrency using excess energy generated. Other uses include providing electrical power to a structure in the event of an emergency and/or supplying electrical power in remote locations.

Embodiments of the present invention include a device that utilizes vehicle movement (primarily forward movement) to spin a gearbox connected to a power generating device(s). The gearbox connects to the wheel hub by a chain, belt, sprocket, gear, or some other suitable material. The gearbox, by utilizing a sophisticated gearing system, turns the electrical power generating device(s) (EPGD) at a constant, high enough revolutions per minute (RPM), for the EPGD to produce maximum output. This will allow the unit to be equally as efficient, in terms of electrical power production, even at lower miles per hour/kilometers per hour (MPHs/KPHs). Electrical power not immediately used will be stored to energy storage components for later use and/or for cryptocurrency mining. This device/unit has the characteristics of serving as a self-sustaining charging station for electric vehicles, while also having cryptocurrency mining capabilities. The present invention, in the near and long-term, will save EV owners money otherwise associated with the charging of their EV, providing immediate economic value, while also making them significantly simpler to own (e.g., an owner won't have to hunt for a charging station as frequently).

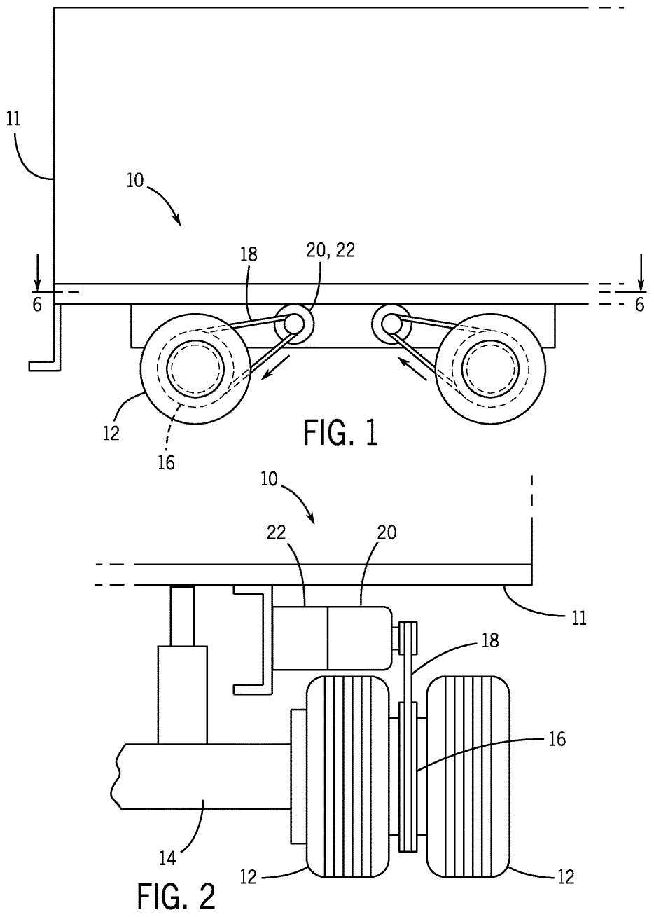

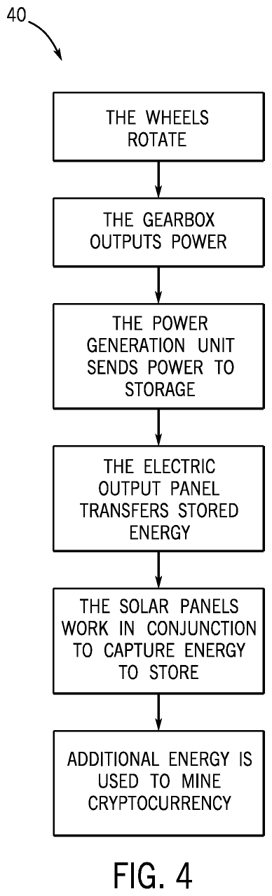

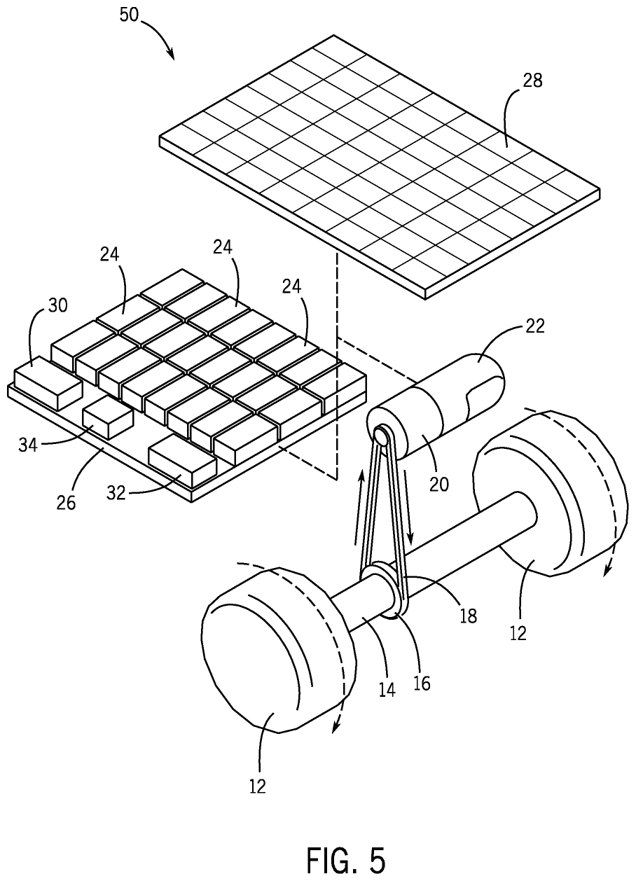

Referring now to FIGS. 1-6, a power generation and cryptocurrency mining device 10 is generally depicted. The device 10 is configured to function with various vehicles 11. For example, it can function with semitrailers that have dual wheels 12, as shown in FIG. 2 (with a portion of the device 10 disposed between the wheels 12), or it can be configured for use along a vehicle axle 14, as shown in a second configuration 50 in FIG. 5. The present invention, as shown in FIG. 1, can be arranged on a plurality of axles (e.g., 1-4+ axles), increasing the overall output of the system (the output discussed in greater detail below). As shown, the axles 14 described herein are the axles 14 traditionally used by a vehicle to support its load and either directly drive the vehicle or be driven by a driving axle 14 (e.g., the non-driving axle on a two-axle vehicle with 2 wheel drive).

Referring to FIGS. 1-3, an electric vehicle 11 includes a wheel hub (mounted on a vehicle axle 14) comprising two wheels 12. The hub is operably connected to a gearbox 20 via a sprocket/gear 16 and belt or chain 18, or other suitable connection that imparts rotation of the gearbox 20 as a result of the rotation of the wheel hub. The gearbox may include a series of gears of various sizes which work to ensure the output (connected to power generating devices 22) gears maximize their rotation, regardless (within reason) of the RPM of the input (connected to the wheel hubs) gear(s). As is conventional in vehicles, the axle 14 is driven to rotate (either directly or indirectly) by a motor (or another drive source), which causes rotation of the wheel hub with the two wheels 12.

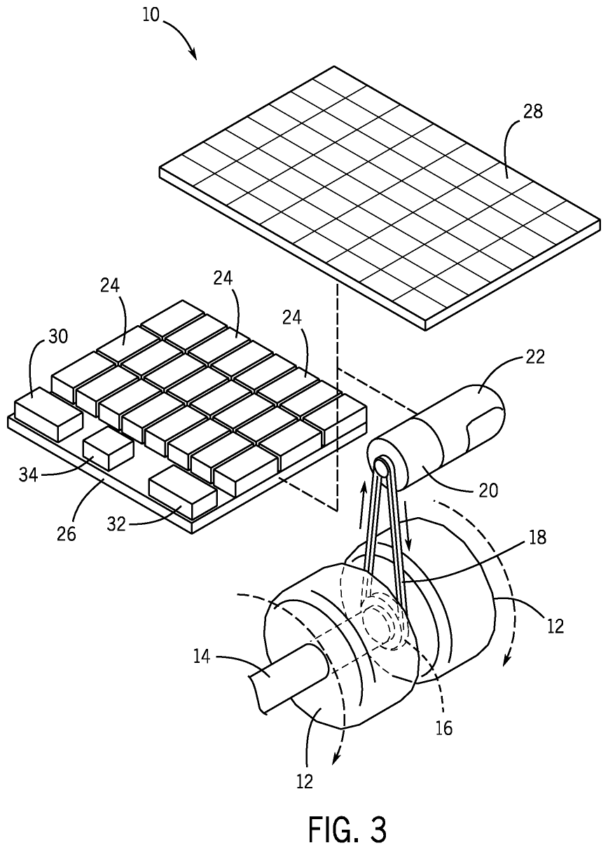

Referring to FIGS. 2 and 3, a power generation device 22 (e.g., a generator) is coupled to the vehicle 11 on one end and connects to the gearbox 20 on its other end (thus being operably coupled to the axle(s) 14). The power generation device 22 converts the mechanical energy of the gearbox 20 to electrical energy (also used synonymously with the term “electricity”), which can be stored in one or more power storage units 24 (which may be but is not necessarily a battery). The power generation device 22 must turn at a minimum RPM, so the gearbox 20 is used like a car transmission by ensuring the input side (connected to the wheels 12), maintains a ratio that allows the output side (connected to the generator) to maintain the required RPM. The gearbox 20 handles this by switching through various gears to maintain the desired output RPM at various speeds.

An onboard computing unit 26 (which includes a processor and memory) is coupled to an electrical output panel 32 (with a bypass for direct power to the EV 11). This panel 32 may be provided with a plurality of connections for someone to power other devices with, including but not limited to, EV connections (plug in), 120 volt outlets, 240 v outlets, as well as at least one high amp output plug in. Further, solar panels 28 may be provided to capture the sun during daylight hours, and stored for later use. The device 10 is also provided with a cryptocurrency mining rig 30 capable of using excess energy to mine cryptocurrency. The rig 30 may also use energy saved in power storage units 22 or any other apparatus on the vehicle that stores energy, and combinations thereof. These cryptocurrency mining rigs 30 typically vary from desktop size to as large as a warehouse. In preferred embodiments, the rig 30 may be positioned on either side of the trailer of the semitrailer (e.g., the driver side of the trailer).

To support the mining (and for global positioning system (GPS), mobile application support, and tracking data), a communication module 34 is also provided. This communication module 34 may include GPS, short-range wireless communication (e.g., BLUETOOTH™) capability, a cellular or other wireless connection, and other appropriate hardware/software/sensors to permit the mining of cryptocurrency as well as collection and monitoring of system data and to transmit all said system data to a user interface medium (such as a mobile application loaded on a computing device, e.g., a tablet or smartphone).

In particular embodiments, communication module 34 includes hardware, software, or both providing one or more interfaces for communication between the computing unit 26 and one or more other computer systems or one or more networks. The present disclosure contemplates any suitable network and any suitable communication module 34 for it. As an example, the computing unit 26 may communicate with an ad hoc network, a personal area network (PAN), a local area network (LAN), a metropolitan area network (MAN), a wide area network (WAN), or one or more portions of the Internet or a combination of two or more of these. As an example, the computing device 26 may communicate with a wireless PAN (WPAN) (such as, for example, a BLUETOOTH™ WPAN), a WI-FI network, a WI-MAX network, a cellular telephone network (such as, for example, a Global System for Mobile Communications (GSM) network), or other suitable wireless network or a combination of two or more of these.

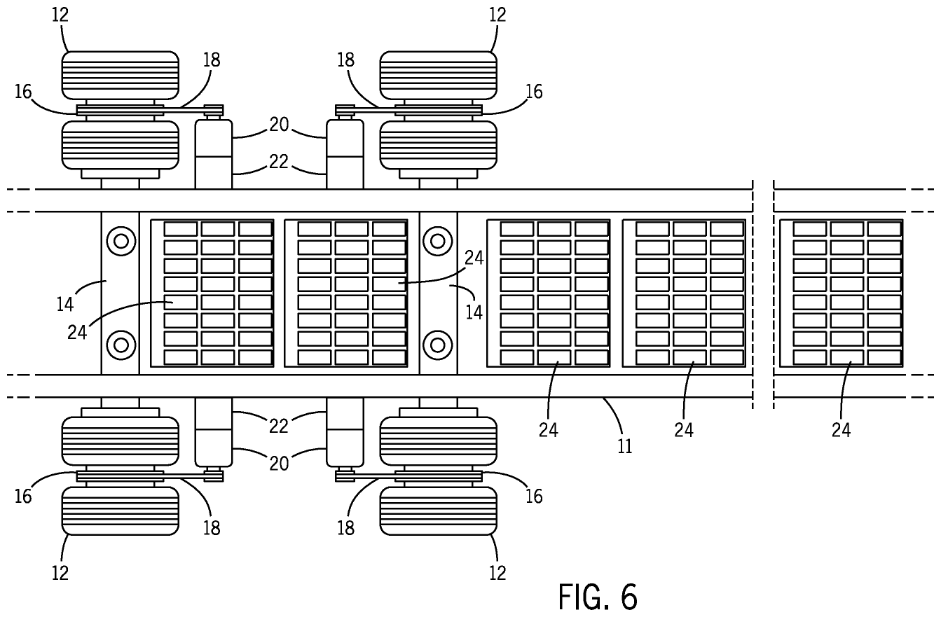

As shown in FIG. 6, a plurality of these aforementioned components may be provided to increase the overall capacity of the system. For example, a device 10 can be positioned in use with each wheel hub of the vehicle, with a plurality of storage units 24 collecting the electrical energy generated from the power generation devices 22.

In use, and as summarized by the flowchart 40 of FIG. 6, gearbox(es) 20 work to ensure the output (connected to the power generating devices 22) gears maximize their rotation, independent the RPM of the input gear(s) 16 (which are connected to the wheel hubs). The power generating device(s) 22 function in a conventional manner as a traditional electric power generator works. Electrical power storage units 24 serve to hold additional electricity generated if all the power is not being directly supplied to the EV. The electrical output panel 32 is the medium utilized to transfer the stored energy. Solar panels 28 (for equipped vehicles 11) will work in conjunction with the unit's forward movement, to also capture solar energy to be stored for later use. The device's ability to produce more electrical energy than it consumes is utilized to mine cryptocurrency via the mining rig 30 while commuting or traveling. Together, through the movement of the EV, the individual components will work together to create usable electrical energy to recharge an EV, power a home (for a period of time), power a camper/RV, and more.

As those with skill in the art will appreciate, the device 10 described herein could also be used with fuel (e.g., gasoline or diesel) powered vehicles, with the energy generated being used for purposes other than recharging a battery. A primary use for this device may be for EV range extension, for long road trips or commercial transportation uses. Secondary uses include, as touched on above, providing electrical power in the event of an emergency or to provide electrical power in remote locations and/or cryptocurrency mining. Additionally, this device 10 can be utilized in the realm of driverless vehicles, artificial intelligence (AI) as it relates to transportation, and the evolution of EVs.

As will be readily apparent to those with skill in the art, this device 10 may be made in various appropriate ways that may result in a differently configured system. In general, most embodiments will include one or more power generators, with applicable power generation and output for the intended purpose, attached to one or more gearbox's output side. The gearbox's input side is attached to a trailer's wheels or directly to one or more vehicle's wheels (thus multiple units could be used on a single vehicle or trailer, as shown in FIG. 6). Then, the power generator(s) are connected to an electrical power storage unit of one or more batteries. Then an electrical output panel is added as a medium to utilize the stored or actively generated power. The communications module, as well as the mining rig, are retained on the vehicle and electrically coupled together, along with the computing device, output panel, and power storage unit.

The generator(s) are vital for the production of the power. Further, in order for there to be proper operation, some type of link or linkage to the wheels or some other rotation mass or assembly onboard the vehicle must be provided. The gearbox(es) are optional, but a minimum and maximum speed will need to be maintained in order to keep the generator(s) turning at an optimal RPM. The electrical storage components are also optional if the power will be used to charge the vehicle while moving.

In other potential embodiments, generator(s) could be connected to some other rotating/spinning mass, shaft, or assembly. That mass could be used instead of the wheels of the vehicle, or of a pull-behind-type trailer. The unit could be scaled up or down depending on the desired application and output. The technology could be even utilized by locomotives, aircrafts, and even water vessels (boats/ships).

While one or more preferred embodiments are disclosed, many other implementations will occur to one of ordinary skill in the art and are all within the scope of the invention. Each of the various embodiments described above may be combined with other described embodiments in order to provide multiple features. Furthermore, while the foregoing describes a number of separate embodiments of the apparatus and method of the present invention, what has been described herein is merely illustrative of the application of the principles of the present invention. Other arrangements, methods, modifications, and substitutions by one of ordinary skill in the art are therefore also considered to be within the scope of the present invention, which is not to be limited except by the claims that follow.

While apparatuses and methods are described in terms of “comprising,” “containing,” or “including” various components or steps, the apparatuses and methods can also “consist essentially of” or “consist of” the various components and steps. All numbers and ranges disclosed above may vary by some amount. Whenever a numerical range with a lower limit and an upper limit is disclosed, any number and any included range falling within the range is specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values. Also, the terms in the claims have their plain, ordinary meaning unless otherwise explicitly and clearly defined by the patentee. Moreover, the indefinite articles “a” or “an,” as used in the claims, are defined herein to mean one or more than one of the elements that it introduces. If there is any conflict in the usages of a word or term in this specification and one or more patent or other documents that may be incorporated herein by reference, the definitions that are consistent with this specification should be adopted. Moreover, the use of directional terms such as above, below, upper, lower, upward, downward, left, right, and the like are used in relation to the illustrative embodiments as they are depicted in the figures, the upward or upper direction being toward the top of the corresponding figure and the downward or lower direction being toward the bottom of the corresponding figure.

As used herein, the phrase “at least one of” preceding a series of items, with the terms “and” or “or” to separate any of the items, modifies the list as a whole, rather than each member of the list (i.e., each item). The phrase “at least one of” allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

What is claimed is:

1. A system comprising:
a vehicle comprising a first axle and a first wheel mounted on the first axle, the first axle and the first wheel being configured to be driven to rotate; and
a first power generation device operably coupled to the first axle such that rotation of the first axle causes electricity to be generated in the first power generation device.

2. The system of claim 1, wherein the vehicle is a semitrailer.

3. The system of claim 2, further comprising a second wheel mounted on the first axle, with the first power generation device being operably coupled to the first axle between the first wheel and the second wheel.

4. The system of claim 3, further comprising;
a gearbox coupled to the power generation device;
a sprocket coupled to the first axle; and
a belt or a chain coupling the gearbox and the sprocket.

5. The system of claim 2, further comprising: one or more power storage units for storing the electricity generated in the first power generation device.

6. The system of claim 5, further comprising: a communication module for wireless communication with a computer system or a network.

7. The system of claim 6, further comprising: a cryptocurrency mining rig that is at least partially powered by the electricity stored in the one or more power storage units.

8. The system of claim 1, further comprising;
a gearbox coupled to the power generation device;
a sprocket coupled to the first axle; and
a belt or a chain coupling the gearbox and the sprocket.

9. The system of claim 1, wherein the electricity generated is used to recharge a battery of the vehicle.

10. The system of claim 1, further comprising:
a second axle provided on the vehicle and a second wheel mounted on the second axle, the second axle and the second wheel being configured to be driven to rotate; and
a second power generation device operably coupled to the second axle such that rotation of the second axle causes electricity to be generated in the second power generation device.
